(19) United States
(12) Patent Application Publication
(10) Pub. No.: US 2008/0305455 A1
(43) Pub. Date: Dec. 11, 2008

(54) Power Transmission Device For Driving a Dental Handpiece

(75) Inventor: William Guscott, Lititz, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: DENTALEZ, INC., Malvern, PA (US)

(21) Appl. No.: 12/134,565

(22) Filed: Jun. 6, 2008

Related U.S. Application Data
(60) Provisional application No. 60/942,518, filed on Jun. 7, 2007.

(51) Int. Cl. A61C 3/00

(52) U.S. Cl. 433/131

(57) ABSTRACT

An elongated flexible power transmission cable couples an electric motor within a control unit with a dental handpiece. The handpiece has a rotatable tool used for performing dental work within a patient's mouth. The power transmission device comprises a generally flexible and elongated cover having a proximal attachment end, a distal attachment end and a longitudinal axis that extends between the proximal and distal attachment ends. The proximal attachment end is mountable to the control unit and the distal attachment end is mountable to the dental handpiece. A generally flexible and elongated driving cable is rotatably positioned within the cover. The driving cable is generally rotatable about the longitudinal axis and has a proximal end for coupling with the electric motor and a distal end for coupling with and driving the dental handpiece. The driving cable transmitting torque from the electric motor to the dental handpiece

### CROSS-REFERENCE TO RELATED APPLICATIONS

This application claims the benefit of U.S. Provisional Patent Application No. 60/942,518 filed Jun. 7, 2007 entitled “Flexible Power Transmission Cable for Driving a Dental Handpiece”.

### BACKGROUND OF THE INVENTION

The present invention relates to a power transmission device, specifically a power transmission device having a flexible power transmission cable for driving a dental handpiece.

Dental practitioners use a variety of tools for dental treatments such as drilling, grinding, polishing, scaling and other periodontal treatments, root canal therapy and the like. A dental practitioner often uses a variety of tools for a single procedure. A drilling tool, a light source, chip air and water are often needed to perform a single procedure. Since a mouth is a small space in which to work and children or those suffering from trismus or an otherwise limited ability to open their mouth, it is often difficult to see well and operate equipment in all regions of the mouth. When a dental practitioner cannot see clearly in the field of work or reach a tooth or gum section at a particular angle, it is more likely that a painful slip can occur or the procedure is otherwise limited. Additionally, more than one hand and or person is needed to operate air, water, light and drilling devices simultaneously or seamlessly.

Dental drills are typically pneumatically or electrically driven with the motor coupled directly to a removable handpiece. Pneumatic drills are useful in high speed configurations but are difficult to accurately control with a foot pedal and often do not provide sufficient torque. Electrically driven drills provide for increased control and torque but results in a larger and much heavier handpiece due to the use of an electric motor and corresponding components proximate the handpiece. The larger size and weight of the electrically driven handpiece hinders dexterity, tires the dental practitioner faster and obstructs the mouth opening and view of the practitioner.

What is therefore needed is a dental tool that has a handpiece having characteristics of a pneumatic drill with the increased torque and precision speed of an electric motor.

### BRIEF SUMMARY OF THE INVENTION

Briefly stated, the present invention is directed to an elongated flexible power transmission cable for coupling an electric motor within a control unit with a dental handpiece. The handpiece has a rotatable tool used for performing dental work within a patient's mouth. The power transmission device comprises a generally flexible and elongated cover having a proximal attachment end, a distal attachment end and a longitudinal axis that extends between the proximal and distal attachment ends. The proximal attachment end is mountable to the control unit and the distal attachment end is mountable to the dental handpiece. A generally flexible and elongated driving cable is rotatably positioned within the cover. The driving cable is generally rotatable about the longitudinal axis and has a proximal end for coupling with the electric motor and a distal end for coupling with and driving the dental handpiece. The driving cable transmits torque from the electric motor to the dental handpiece

In another aspect, the invention is directed to a power transmission device for driving a dental handpiece that has a rotatable tool for performing dental work within a patient's mouth. The power transmission device comprises a control unit housing an electric motor and a flexible power transmission cable. The flexible power transmission cable includes a generally flexible and elongated cover that has a proximal attachment end, a distal attachment end and a longitudinal axis that extends between the proximal and distal attachment ends. The proximal attachment end is mounted to the control unit and the distal attachment end is mountable to the dental handpiece. A generally flexible and elongated driving cable rotatably positioned within the cover. The driving cable is generally rotatable about the longitudinal axis and has a proximal end coupled with the electric motor and a distal end for coupling with and driving the dental handpiece such that torque is transmitted from the electric motor to the dental handpiece.

In another aspect, the invention is directed to a power transmission device for driving a dental handpiece that has a rotatable tool for performing dental work within a patient's mouth. The power transmission device comprises a control unit that houses an electric motor. The control unit has a display screen and at least one control button. A flexible power transmission cable includes a generally flexible and elongated cover that has a proximal attachment end, a distal attachment end and a longitudinal axis extending between the proximal and distal attachment ends. The proximal attachment end has a threaded collar that is removably mounted to the control unit and the distal attachment end is removably mountable to the dental handpiece. A generally flexible and elongated driving cable is rotatably positioned within the cover. The driving cable is generally rotatable about the longitudinal axis and has a proximal end coupled with the electric motor and a distal end coupled with and driving the dental handpiece such that torque is transmitted from the electric motor to the dental handpiece. A water line extends from the control unit through the flexible power transmission cable to the dental handpiece. An air line extends from the control unit through the flexible power transmission cable. A delivery system connected to the control unit delivers air and water to the air and water lines respectively. A foot pedal that controls the speed of the electric motor is connected to the delivery system.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a perspective view of a power transmissions device having a control unit and flexible power transmission cable in accordance with a preferred embodiment of the present invention connected to a dental handpiece and schematically connected to a delivery system and foot pedal;

FIG. 2 is a left side elevational view of the flexible power transmission cable shown in FIG. 1;

FIG. 3 is a cross sectional view, partially broken, of the cable shown in FIG. 2 taken along line 3-3 in FIG. 2;

FIG. 4 is a left side elevational view of a handpiece coupler shown in FIG. 1;

FIG. 5 is a right side elevational view of the flexible power transmission cable shown in FIG. 1; and

FIG. 6 is a cross sectional view of the handpiece coupler shown in FIG. 5 taken along line 6-6 of FIG. 5.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of a power transmission device for driving a dental handpiece in accordance with the present invention, and designated parts thereof. Unless specifically set forth herein, the terms “a”, “an” and “the” are not limited to one element but instead should be read as meaning “at least one”. The terminology includes the words noted above, derivatives thereof and words of similar import.

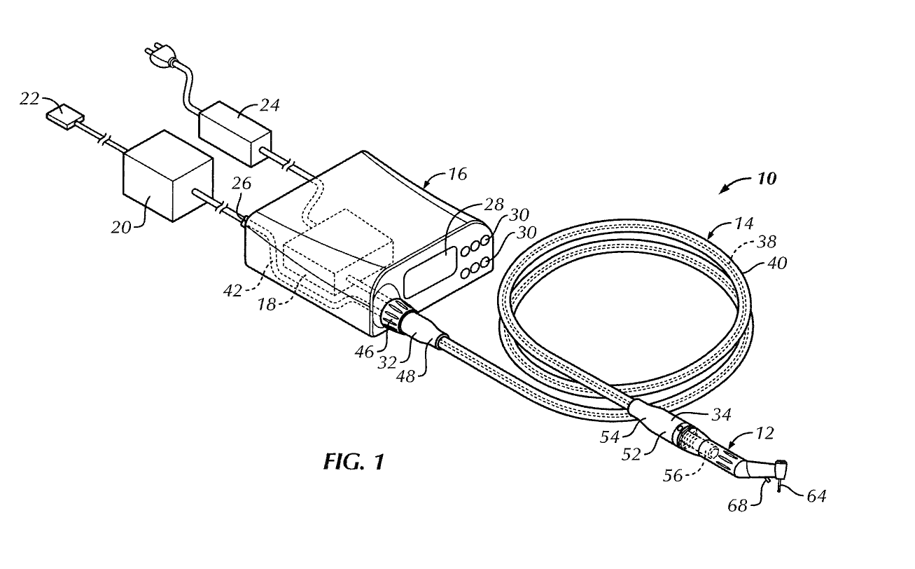

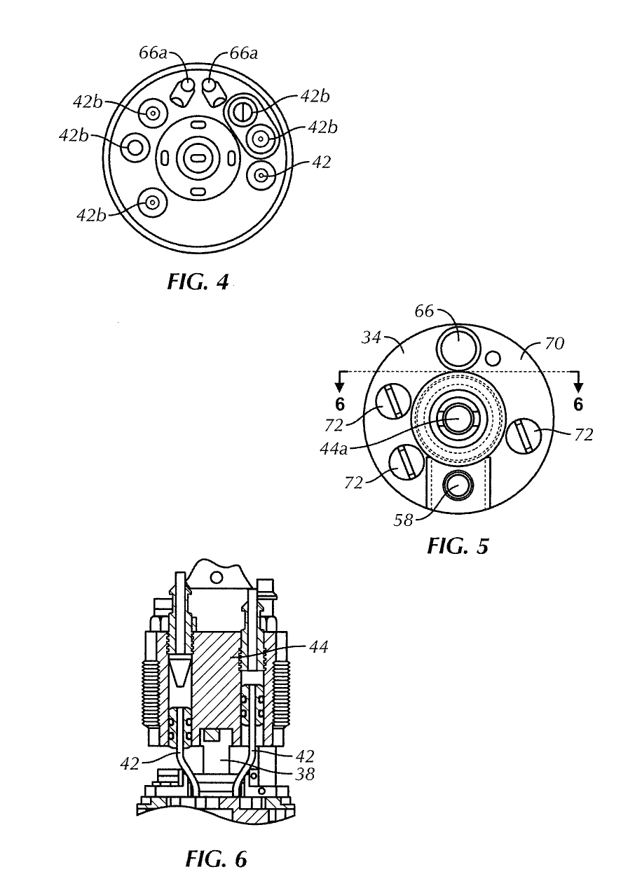

Referring to the drawings, wherein like numerals indicate like elements throughout, there is shown in FIGS. 1-6 a power transmission device, generally designated 10, for driving a dental handpiece (handpiece) 12. The power transmission device 10 includes a flexible power transmission cable 14 that couples a control unit 16 to a detachable drill or other handpiece 12. The handpiece 12 is similar to those known in the art that are removably latched or coupled to the driving end of a pneumatic or electric motor. The handpiece 12 is for performing dental work on a tooth or related area as discussed in further detail below.

The control unit 16 houses electrical components and an electric motor 18 for powering and driving the handpiece 12. The control unit 16 includes a plurality of inlet ports, partially shown at 26, for supplying water and air for use in the handpiece 12. The control unit 16 is operatively connected to a delivery system 20 (shown schematically) proximate a dental chair (not shown) and a foot pedal 22 (shown schematically) that is connected to the delivery system 20. The foot pedal 22 controls the speed of the electric motor 18. The foot pedal 22 is placed on the floor proximate the dental chair to allow the dental practitioner to control the speed of the handpiece 12 with his or her foot. The control unit 16 preferably includes a display screen 28. The display screen 28 is preferably an LCD or similar electronic screen for displaying settings and operating conditions of the control unit 16. The control unit 16 also preferably includes at least one control button or switch 30 for controlling various settings of the control unit 16. Alternatively, the control buttons 30 may be positioned remotely from the control unit 16 such as on the dental chair, the delivery system 20, the foot pedal 22 or on the flexible power transmission cable 14 proximate to the handpiece 12. The speed of the electric motor 18 may be displayed on the display screen 28. The control buttons 30 allow a user to set torque and speed limits of the flexible power transmission cable 14. Other settings include but are not limited to turning on a light 66 (described further below), setting auto-reverse on, programming what specific attachment or handpiece 12 is being used and also various other pre-sets for the power transmission device 10. The control unit 16 is preferably powered by a power supply 24. However, the control unit 16 may alternatively be powered through the delivery system 20.

Referring to FIGS. 1-3, the flexible power transmission device 10 includes a proximal attachment end 32 and a distal attachment end 34. A longitudinal axis 36 (FIG. 3) extends between the proximal and distal attachment ends 32, 34. The flexible power transmission cable 14 includes a driving cable 38 which is generally rotatable about the longitudinal axis 36. The driving cable 38 is preferably a braided or winding type metallic cable but the driving cable 38 may be comprised of nearly any material and configuration such that the driving cable 38 has the thinnest cross section strong enough to withstand the torque needed to the drive the dental handpiece 12. The driving cable 38 includes a keyed proximal end 38a that is sized and shaped to fit within or to be otherwise secured to the output shaft (not shown) of the electric motor 18. Alternatively, the proximal end 38a may included a threaded collar (not shown) that is threadably attached to the output shaft of the electric motor 18. The distal end of the driving cable 38 is attached to and drives an output shaft 44. The driving cable 38 is preferably fixedly attached to the output shaft 44 (see FIG. 6) but the driving cable 38 and the output shaft 44 may be integrally formed.

The flexible power transmission device 10 includes a flexible and elongated cable covering or cover 40. The cover 40 is a flexible outer covering to protect the driving cable 38 and air and water lines 42. The cable covering 36 is preferably constructed of a polymeric material specifically a PEEK covering. However, the cable covering 36 may be constructed of any suitable material such as a wound metal covering to provide a flexible, lightweight and durable protective cover. The cover 40 is preferably mounted or attached to the driving cable 38 at the proximal and distal attachment ends 32, 34 of the flexible power transmission cable 14. The cover 40 is preferably attached to the driving cable 38 by a ball bearing ring 68 or any suitable connector such that the driving cable 38 may rotate relative to the cover 40.

The proximal attachment end 32 of the flexible power transmission cable 14 is preferably removably mounted to the control unit 16 though the power transmission cable 14 may be fixedly attached to the control unit 16. The proximal attachment end 32 of the flexible power transmission cable 14 preferably includes a threaded collar 46 that is rotatably mounted to the proximal attachment end 32 of the flexible power transmission cable 14 and threadingly attaches to the control unit 16. The proximal attachment end 32 of the flexible power transmission cable 14 also preferably includes a backshell 48. The collar 46 is rotatably mounted over the backshell 48. Tightening the collar 48 in the appropriate direction draws the proximal attachment end 32 of the flexible power transmission cable 14 toward the control unit 16 and engages the driving cable 38 with the electric motor 18.

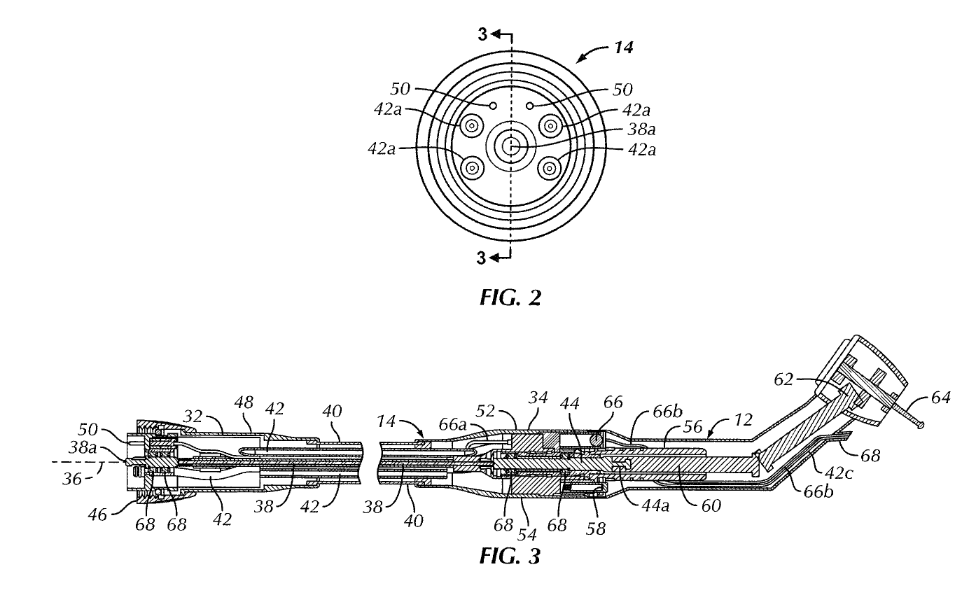

Referring to FIGS. 2, 3 and 4, the proximal attachment end 32 of the flexible power transmission cable 14 preferably includes at least one and preferably two spaced apart pins 50 for insertion within and electrical connection to the control unit 16. The pins 50 are used to establish an electrical connection for any of the electrical components of the handpiece 12. The proximal attachment end 32 also preferably includes a plurality of ports 42a for connecting to the air and water lines 42. The ports 42a are preferably fluidly engaged with a corresponding plurality of air and water lines 42 within the control unit 16. The ports 42a and corresponding air and water lines 42 are preferably arranged to at least provide an air port for cooling the light 66 and other components and a port 42c for providing chip water. The air and water lines 42 run along side of and are preferably radially outwardly spaced from the driving cable 38 and are preferably circumferentially spaced from each other within the cover 40.

Referring to FIGS. 3 and 6, the output shaft 44 is housed within a handpiece coupler 52 at the distal attachment end 34 of the flexible power transmission cable 14. The output shaft 44 has a t-shaped distal end 44a. The handpiece coupler 52 includes a coupler backshell 54 that preferably fixedly extends partially over the distal end of the cover 40. A handpiece plug (plug) 56 extends from the distal end of the handpiece coupler 52 and preferably covers the output shaft 44 to protect users from the output shaft 44 when the handpiece 12 is removed. The handpiece 12 receives the plug 56 and snap fits into releasble engagement with the handpiece coupler 52. A spring biased releasable catch 58 is preferably disposed within the handpiece coupler 52. When the handpiece 12 is pulled away from the handpiece coupler 52 with a sufficient force, the catch 58 radially releases the handpiece 12 from the handpiece coupler 52. An end cap 70 is preferably mounted to the distal end of the handpiece coupler 52 and held in place by a plurality of screws 72 (FIG. 5).

The distal end 44a of the output shaft 44 engages with a drive shaft 60 within the handpiece 12. The drive shaft 60 drives a gear train 62 for powering a rotating tool such as a drill bit 64. The water line 42 connects with the water line 42c in the handpiece 12. The water is sprayed from a nozzle 68 in the handpiece 12 and is used to clear and cool the drill bit 64 and clear or clean the work area. The light bulb 66, positioned toward the distal end of the handpiece coupler 52 emits light from the end of the nozzle 68 in the proximity of the drill bit 64 and the work area to enable a better view when working inside the mouth. The light from the light bulb 66 is brought through the handpiece 14 to the work area through a lumen 66b. The light bulb 66 is connected to power wires 66a inside the cover 40 by crimped AMP or other connectors (not shown).

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the appended claims.

I/We claim:

1. An elongated flexible power transmission cable for coupling an electric motor within a control unit with a dental handpiece, the dental handpiece having a rotatable tool used for performing dental work within a patient's mouth, the power transmission device comprising:
a generally flexible and elongated cover having a proximal attachment end, a distal attachment end and a longitudinal axis extending between the proximal and distal attachment ends, the proximal attachment end mountable to the control unit and the distal attachment end mountable to the dental handpiece; and
a generally flexible and elongated driving cable rotatably positioned within the cover, the driving cable being generally rotatable about the longitudinal axis and having a proximal end for coupling with the electric motor and a distal end for coupling with and driving the dental handpiece for transmitting torque from the electric motor to the dental handpiece.

2. The power transmission device of claim 1, wherein the proximal attachment end of the cover includes a rotatably mounted collar having threads.

3. The power transmission device of claim 1 further comprising a light member.

4. The power transmission device of claim 3, wherein the light member is positioned proximate the distal attachment end of the cover and an electrical power wire extends within the cover from the light member to the proximal attachment end.

5. The power transmission device of claim 1, wherein a plug extends from the distal attachment end of the cover for shielding the distal end of the driving cable.

6. The power transmission device of claim 1, wherein the distal attachment end of the cover includes a releasable catch for retaining the handpiece to the distal attachment end.

7. The power transmission device of claim 1 further comprising a water line extending within the cover between the proximal and distal attachment ends.

8. The power transmission device of claim 1 further comprising a control unit mounted to the proximal attachment end of the cover, the control unit rotatably driving the driving cable.

9. The power transmission device of claim 8 further comprising a pedal operatively connected to the control unit and controlling rotational speed of the power transmission cable.

10. The power transmission device of claim 8 further comprising a dental handpiece removably mounted to the distal attachment end of the cover and having a rotatable tool driven by the driving cable.

11. The power transmission device of claim 1, wherein the driving cable is rotatably connected to the cover at the proximal and distal attachment ends of the cover by a plurality of bearings.

12. A power transmission device for driving a dental handpiece having a rotatable tool for performing dental work within a patient's mouth comprising:
a control unit housing an electric motor; and
a flexible power transmission cable including:
a generally flexible and elongated cover having a proximal attachment end, a distal attachment end and a longitudinal axis extending between the proximal and distal attachment ends, the proximal attachment end mounted to the control unit and the distal attachment end mountable to the dental handpiece, and
a generally flexible and elongated driving cable rotatably positioned within the cover, the driving cable generally rotatable about the longitudinal axis and having a proximal end coupled with the electric motor and a distal end for coupling with and driving the dental handpiece such that torque is transmitted from the electric motor to the dental handpiece.

13. The power transmission device of claim 12 further comprising a pedal operatively connected to the control unit and controlling operational speed of the motor.

14. The power transmission device of claim 12 wherein the control unit includes a display.

15. The power transmission device of claim 12 wherein the control unit includes at least one control button.

16. A power transmission device for driving a dental handpiece having a rotatable tool for performing dental work within a patient's mouth comprising:
a control unit housing an electric motor, the control unit having a display screen and at least one control button;
a flexible power transmission cable including:
a generally flexible and elongated cover having a proximal attachment end, a distal attachment end and a longitudinal axis extending between the proximal and distal attachment ends, the proximal attachment end having a threaded collar removably mounted to the control unit and the distal attachment end being removably mountable to the dental handpiece, and
a generally flexible and elongated driving cable rotatably positioned within the cover, the driving cable generally rotatable about the longitudinal axis and having a proximal end coupled with the electric motor and a distal end coupled with and driving the dental handpiece such that torque is transmitted from the electric motor to the dental handpiece,
a water line extending from the control unit through the flexible power transmission cable to the dental handpiece;
an air line extending from the control unit through the flexible power transmission cable;
a delivery system connected to the control unit delivers air and water to the air and water lines respectively; and
a foot pedal controlling the speed of the electric motor being connected to the delivery system.
